(19) United States
(12) Patent Application Publication
(10) Pub. No.: US 2007/0043455 A1
(43) Pub. Date: Feb. 22, 2007

(54) Apparatus and methods for automated sequential movement control for operation of a remote navigation system

(76) Inventors: Raju R. Viswanathan, St. Louis, MO (US); Walter M. Blume, St. Louis, MO (US); Nathan Kastelein, St. Louis, MO (US); Jeffrey M. Garibaldi, St. Louis, MO (US)

Correspondence Address: HARNESS, DICKEY, & PIERCE, P.L.C, 7700 BONHOMME, STE 400, ST. LOUIS, MO, 63105, US

(21) Appl. No.: 11/486,990

(22) Filed: Jul. 14, 2006

Related U.S. Application Data
(60) Provisional application No. 60/702,482, filed on Jul. 26, 2005.

(51) Int. Cl. G05B 19/18

(52) U.S. Cl. 700/66

(57) ABSTRACT

A method of defining automated movement sequences of a remotely controlled medical device actuated by a remote navigation system includes the steps of: defining a reference length for a medical device inserted into an anatomical chamber where subsequent device length measurements are made and automated device length changes are applied with respect to the reference length, and defining a movement sequence as a concatenation of automated movement building block primitives for subsequent automated execution by the remote navigation system.

### CROSS-REFERENCE TO RELATED APPLICATIONS

This application claims the benefit of U.S. Provisional Patent Application Ser. No. 60/702,482, filed Jul. 26, 2005, the entire disclosure of which is incorporated herein by reference.

### FIELD

The present invention relates to remote navigation systems that remotely actuate medical devices, and in particular to methods of automation of sequential device movements in the operation of remote navigation systems.

### BACKGROUND

Remote navigation systems which remotely orient the distal end of an elongate medical device in a selected direction are making medical navigation through the body faster and easier, and are allowing physicians to reach locations that could not be reached with conventional manual devices. These remote navigation systems also allow for the automation of navigation, which is useful in a number of diagnostic and therapeutic procedures, including mapping.

Medical procedures such as minimally interventional diagnosis and treatment of cardiac arrhythmias in electrophysiology often involve steering a localized medical device such as a catheter within anatomical regions in order to create a geometrical representation or map of the anatomical chamber of interest. In such a procedure, a localized catheter is steered to various sites within the anatomical chamber, and the three dimensional coordinates at each such location are recorded by a localization system after confirming that the device is indeed in contact with an internal wall, thereby providing data for the creation of a geometric map of the internal surface of the chamber. Wall contact confirmation is provided, for instance, from intra-cardiac ECG data, for which purpose the catheter is also equipped with ECG recording electrodes. An example of a system that helps create such a map is the CARTO™ EP Mapping system manufactured by Biosense Webster Inc., wherein the system renders a continuous interpolated surface given a discrete set of “visited” interior or internal surface points as input.

This type of procedure is commonly performed “by hand” with a manually steered catheter, and so it can be a laborious process; a typical map can have in excess of 80 or 100 points. With the recent advent of remote navigation systems such as the Niobe® Magnetic Navigation System manufactured by Stereotaxis, Inc. of St. Louis, Mo., it is possible to automate the navigation process needed to create a map, or a portion of a map, providing a significant increase in procedural efficiency for the physician.

There are several types of remote navigation systems. Each typically includes an orientation system for orienting the distal end of a medical device and a positioning system which advances and retracts the medical device. One such system is a magnetic navigation system which uses one or more external magnets (electromagnets or compound permanent magnets). To project a field into the operating region in a subject to act on magnetically responsive elements in the distal end of the medical device to orient the distal end in a selected direction. A device positioning system advances and retracts the medical device.

Another remote navigation system is a mechanical navigation system which uses a guide which is mechanically operated (with push wires, pull wires, gears, other mechanical elements) to a selected direction. A positioning system advances and retracts a medical device through the guide in a selected direction. Although not nearly as capable as magnetic navigation systems, such systems can be developed by Stereotaxis, Inc. and others.

Other remote navigation systems under development include electrostrictive, magnetostrictive and fluid pressure systems for remotely orienting the distal end of a medical device.

Efforts are being continually made to improve the ability to control remote navigation systems, and in particular to facilitate communication between the physician and the system.

### SUMMARY

This invention, in one aspect, is directed to a method of controlling automated operation of a remote navigation system including an orientation system and a positioning system. A sequence of automated movement “building blocks” or primitives are defined on the system by a user in order to execute a series of sequential device movements of a medical device within a patient anatomy in automated fashion. Some embodiments of the present invention provide methods of, and graphics user interfaces and controllers for, operating remote navigation systems.

According to one aspect of this invention, methods of operating remote navigation systems which have orientation and positioning systems are provided that can implement one or more of the following:

1. Setting a retraction limit for the positioning system to ensure that the medical device is not inadvertently withdrawn from a location (e.g. a chamber of the heart) during automated movements.

2. Advancing the positioning system to an absolute length. Based on a calibrated device length, the positioning system is operated to advance or retract the device until a desired length is achieved. This is useful at the start of a series of movements to ensure that the movement pattern is starting from a known position.

3. Moving a relative amount. The positioning system is advanced or retracted a specified length (preferably in mm). This is useful in implementing drag operations (dragging the distal end of the device on an anatomical surface as is done in certain mapping and ablation procedures) and could be combined with orientation changes to create multi-step motions.

4. Setting orientation. This operates the orientation system to orient the distal end of the device in a selected orientation. In the case of a magnetic navigation system this might alternatively be set field direction. This is useful at the start of a series of motions to ensure patters are starting from a known direction.

5. Advance until deflection. This operates the positioning system to advance the medical device until the tip deflects (indicating a contact with an anatomical surface). The deflection preferably must exceed a predetermined threshold, and for safety is limited to a predetermined maximum advancement. This is useful to ensure contact with an anatomical surface or increase contact force.

6. Adjust Direction Until Deflection. This operates the orientation system to change the orientation of the medical device until the tip deflects (indicative of contact with an anatomical surface). In the case of a magnetic navigation system this is done by changing the magnetic field direction. This is useful to ensure contact with an anatomical surface or increase contact force.

7. Drag While Contact is Maintained. The positioning system is operated to drag (retract) the medical device a specific amount. The drag operation is terminated if device tip orientation changes to indicate surface contact is lost. This allows drag lines to be automatically implemented (for example in mapping or ablation).

According to another aspect of this invention, graphical user interface for a remote navigation system is provided that can implement one or more of the following:

1. Setting a retraction limit for the positioning system to ensure that the medical device is not inadvertently withdrawn from a location (e.g. a chamber of the heart) during automated movements.

2. Advancing the positioning system to an absolute length. Based on a calibrated device length, the positioning system is operated to advance or retract the device until a desired length is achieved. This is useful at the start of a series of movements to ensure that the movement pattern is starting from a known position.

3. Moving a relative amount. The positioning system is advanced or retracted a specified length (preferably in mm). This is useful in implementing drag operations (dragging the distal end of the device on an anatomical surface as is done in certain mapping and ablation procedures) and could be combined with orientation changes to create multi-step motions.

4. Setting orientation. This operates the orientation system to orient the distal end of the device in a selected orientation. In the case of a magnetic navigation system this might alternatively be set field direction. This is useful at the start of a series of motions to ensure patters are starting from a known direction.

5. Advance until deflection. This operates the positioning system to advance the medical device until the tip deflects (indicating a contact with an anatomical surface). The deflection preferably must exceed a predetermined threshold, and for safety is limited to a predetermined maximum advancement. This is useful to ensure contact with an anatomical surface or increase contact force.

6. Adjust Direction Until Deflection. This operates the orientation system to change the orientation of the medical device until the tip deflects (indicative of contact with an anatomical surface). In the case of a magnetic navigation system this is done by changing the magnetic field direction. This is useful to ensure contact with an anatomical surface or increase contact force.

7. Drag While Contact is Maintained. The positioning system is operated to drag (retract) the medical device a specific amount. The drag operation is terminated if tip orientation changes to indicate surface contact is lost. This allows drag lines to be automatically implemented (for example in mapping or ablation).

According to another aspect of this invention, a control for a remote navigation system is provided that can implement one or more of the following:

1. Setting a retraction limit for the positioning system to ensure that the medical device is not inadvertently withdrawn from a location (e.g. a chamber of the heart) during automated movements.

2. Advancing the positioning system to an absolute length. Based on a calibrated device length, the positioning system is operated to advance or retract the device until a desired length is achieved. This is useful at the start of a series of movements to ensure that the movement pattern is starting from a known position.

3. Moving a relative amount. The positioning system is advanced or retracted a specified length (preferably in mm). This is useful in implementing drag operations (dragging the distal end of the device on an anatomical surface as is done in certain mapping and ablation procedures) and could be combined with orientation changes to create multi-step motions.

4. Setting orientation. This operates the orientation system to orient the distal end of the device in a selected orientation. In the case of a magnetic navigation system this might alternatively be set field direction. This is useful at the start of a series of motions to ensure patters are starting from a known direction.

5. Advance until deflection. This operates the positioning system to advance the medical device until the tip deflects (indicating a contact with an anatomical surface). The deflection preferably must exceed a predetermined threshold, and for safety is limited to a predetermined maximum advancement. This is useful to ensure contact with an anatomical surface or increase contact force.

6. Adjust Direction Until Deflection. This operates the orientation system to change the orientation of the medical device until the tip deflects (indicative of contact with an anatomical surface). In the case of a magnetic navigation system this is done by changing the magnetic field direction. This is useful to ensure contact with an anatomical surface or increase contact force.

7. Drag While Contact is Maintained. The positioning system is operated to drag (retract) the medical device a specific amount. The drag operation is terminated if device tip orientation changes to indicate surface contact is lost. This allows drag lines to be automatically implemented (for example in mapping or ablation).

### BRIEF DESCRIPTION OF THE DRAWINGS

The present invention will become more fully understood from the detailed description and the accompanying drawings, wherein:

FIG. 1 is an illustration of a map obtained using an automated anatomical mapping process in accordance with one implementation of the invention; and

FIG. 2 is a block diagram of a system for controlling a medical device including a remote navigation system in accordance with one implementation of the invention.

### DETAILED DESCRIPTION

The present invention relates to methods of operating remote navigation systems, and graphical user interfaces and controllers for operating remote navigation systems. These remote navigation systems typically comprise an orientation system for orienting the distal end of an elongate medical device such as a catheter, and a positioning system for advancing and retracting the elongate medical device.

One such remote navigation system is a magnetic navigation system which has one or more magnets outside the body which create a magnetic field in a selected direction inside the body which acts on a magnetically responsive element associated with the distal end of the medical device to orient the distal end of the medical device.

Another such remote navigation system is a mechanical navigation system which has a guide which can be mechanically oriented to orient the distal end of a medical device that is advanced and retracted through the guide.

Still other remote navigation systems use electrostrictive, magnetostrictive, or fluid elements to remotely orient the distal end of the medical device.

While the embodiments of the invention are primarily described with reference to magnetic navigation systems, the invention is not so limited and can be applied to any remote navigation system that has an orientation and a positioning system. Generally this description of various embodiments is merely exemplary in nature and is in no way intended to limit the invention, its application, or uses.

The invention, in some aspects, is directed to a method of performing automated anatomical mapping using a remote navigation system. Such systems include but are not limited to magnetic navigation systems and mechanically operated navigation systems. In some implementations, a user of a remote navigation system may combine a plurality of movement primitives defined in the system to realize complex movements of a medical device in the anatomy of a patient. Such primitives may be implemented in a navigation system having an orientation system and a positioning system and include those that are described below in what follows.

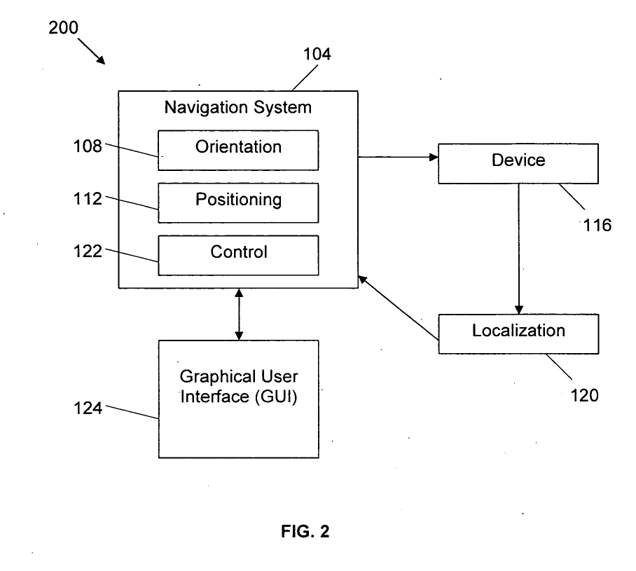

An exemplary system for controlling a medical device in the body of a patient is indicated generally in FIG. 2 by reference number 100. A remote navigation system 104 including an orientation system 108 and a positioning system 112 is operable to navigate a medical device 116 in a patient. The device 116 may be, for example, a catheter. Locations of the device 116 are tracked using a localization system 120. A control system 122 is configured to control the orientation system 108 and positioning system 112. A user communicates with the control system 122 via a graphical user interface (GUI) 124. The control 122 may act, in response to a user command via the GUI 124, to operate the positioning and/or orientation systems as described herein to control the device 116.

Drag While Contact is Maintained

In accordance with a preferred embodiment of the methods of the invention, a remote navigation system is operated so that in response to an appropriate user command (which can be input with a physical control but which is preferably input with a graphical user interface) the positioning system is operated to retract the medical device while the distal end of the medical device remains in contact with an anatomical surface. More preferably the device is retracted a predetermined distance (which preferably can be set by the user) but is interrupted if the distal tip of the device loses contact with the anatomical surface. This is particularly useful in acquiring data points for mapping the surface or forming lines of ablation on the surface.

Contact with the surface can be determined using a contact sensor such as a pressure sensor. However, contact with the surface can also be determined from the orientation of the distal end of the medical device. For example, when a magnetic navigation system applies a magnetic field of a particular direction, the distal end of the medical device can be expected to assume a corresponding orientation. If the distal end of the medical device does not assume the expected orientation, it can be attributed to an outside influence—namely contact with a surface. Thus by monitoring the orientation of the distal end of the medical device (which can be conveniently done with available medical localization systems) it can be determined when the distal end of the medical device is in contact with an anatomical surface.

Thus in accordance with one implementation of this embodiment, the positioning system is operated to retract the medical device so long as the distal tip remains at an orientation indicative of contact with an anatomical surface, or until a predetermined length of retraction is reached.

In accordance with another implementation of this embodiment, the positioning system is operated to retract the medical device until a predetermined change in orientation of the distal tip occurs, or until a predetermined length of retraction is reached.

In accordance with another implementation of this embodiment, the positioning system is operated to retract the medical device until the orientation of the distal tip comes within a predetermined amount of an angular orientation that indicates contact with an anatomical surface, or until a predetermined length of retraction is reached.

In accordance with another implementation of this embodiment, the positioning system is operated to retract the medical device until the orientation of the distal tip is within a predetermined amount of the predicted orientation based upon the stat (e.g. the control variable inputs, ore the actual input) of the orientation system, or until a predetermined length of retraction is reached.

In operation, in response to user inputs the orientation system and the positioning system are operated to bring the distal tip of the medical device into contact with an anatomical surface. Thereafter in response to a further user command operating the positioning system to retract the medical device a predetermined amount, or until the device loses contact with the anatomical surface (preferably as determined by the angular orientation of the medical device).

These methods are preferably implemented by a control, and more preferably a computer control that operates the orientation system and positioning system. Simple controls, e.g. a button, can be provided, but more preferably a graphical user interface is provided that allows the user to set feature parameters such as predetermined length of retraction, and for actuating the feature such as by pointing and clicking.

Advance Until Deflection

In accordance with a preferred embodiment of the methods of this invention, a remote navigation system is operated so that in response to an appropriate user command (which can be input with a physical control but which is preferably input with a graphical user interface) the positioning system is operated to advance the medical device until the orientation of the distal tip of the device indicates the device is in contact with an anatomical surface.

The change in orientation of the distal tip of the medical device is an indicator of contact. For example, in the case of a magnetic navigation system, a particular magnetic field orientation typically has a corresponding device orientation. When the orientation of the distal end of the device varies from this corresponding device orientation it is indicative of outside influence—contract with an anatomical surface.

Thus by monitoring the orientation of the distal tip (for example with any medical localization system) contact with an anatomical surface can be detected.

Thus in accordance with one implementation of this embodiment, in response to a user command the positioning system is operated until the orientation of the distal tip indicates contact, and more preferably until the orientation of the distal tip changes a predetermined amount.

In accordance with another implementation of this embodiment, in response to a user command the positioning system is operated until the orientation of the distal tip indicates contact, and more specifically until the actual orientation of the distal tip is greater than a predetermined amount from the predicted orientation of the distal tip based upon the state of the orientation system (e.g. operating parameters or output condition).

In accordance with another implementation of this embodiment, in response to a user command the positioning system is operated until the orientation of the distal tip indicates contact, and more specifically until the orientation of the distal end of the medical device changes a predetermined amount from the orientation at which the orientation of the device first began to change.

These methods are preferably implemented by a control, and more preferably a computer control that operates the orientation system and positioning system. Simple controls, e.g. a button, can be provided, but more preferably a graphical user interface is provided that allows the user to set feature parameters such as predetermined amounts, and for actuating the feature such as by pointing and clicking.

In operation, in response to user inputs the orientation system and the positioning system are operated to bring the distal tip of the medical device into a desired location. Thereafter in response to a further user command, operating the positioning system to advance the medical device until the distal tip contacts an anatomical surface as indicated by the orientation of the distal tip.

Adjust Direction Until Deflection

In accordance with a preferred embodiment of the methods of this invention, a remote navigation system is operated so that in response to an appropriate user command (which can be input with a physical control but which is preferably input with a graphical user interface) the orientation system is operated to change the orientation of the distal tip, until the orientation of the distal tip indicates contact with an anatomical surface.

The change in orientation of the distal tip of the medical device is an indicator of contact. For example, in the case of a magnetic navigation system, a particular magnetic field orientation typically has a corresponding device orientation. When the orientation of the distal end of the device varies from this corresponding device orientation it is indicative of outside influence—contract with an anatomical surface.

Thus by monitoring the orientation of the distal tip (for example with any medical localization system) contact with an anatomical surface can be detected.

Thus in accordance with one implementation of this embodiment, in response to a user command the orientation system is operated until the orientation of the distal end of the medical device indicates contact, and more preferably until actual orientation differs from the predicted orientation based upon the state of the orientation system (e.g. control variables or actual output) by a predetermined amount.

In operation, in response to user inputs the orientation system and the positioning system are operated to bring the distal tip of the medical device into a desired location. Thereafter in response to a further user command, operating the orientation system until the distal tip contacts an anatomical surface as indicated by a change in the orientation of the distal tip.

These methods are preferably implemented by a control, and more preferably a computer control that operates the orientation system and positioning system. Simple controls, e.g. a button, can be provided, but more preferably a graphical user interface is provided that allows the user to set feature parameters such as predetermined amounts, and for actuating the feature such as by pointing and clicking.

An example of a medical procedure shall now be described to illustrate usage of the foregoing and additional primitives. In the present example, a remotely navigated catheter device is inserted into the anatomical chamber of interest through an appropriate entry point. For example, in the case of cardiac left atrial mapping performed to treat atrial fibrillation (AF), the entry point into the left atrium is a trans-septal puncture at the fossa ovalis in the septum separating the right and left atria. The catheter may pass through a sheath or other device that is used to provide additional mechanical support at the entry position. The length of inserted device is recorded for catheter length calibration purposes, for example, at the entry point into the chamber (in this case zero length is used as reference) or after the catheter has been inserted some distance into the chamber. In the latter case the length inserted is computed, for instance, by marking the base position and orientation of the device, and the position of the device tip, on a pair of fluoro images, and using knowledge of current actuation control variables together with a computational model of the device to compute the length of device needed to reach the marked tip position of the device. Then, for example, a “Set Reference” tab on a graphical user interface menu could be used to set the reference position from which subsequent length measurements are made.

Once a reference for the device length has been set, all further length changes of the device (insertion or retraction) within the chamber can be tracked by mechanical, optical or other means. For example, in the cases of a magnetic navigation system or a mechanically operated navigation system that uses mechanical means to insert or retract the device, a rotational encoder connected to wheels that mechanically move the device can provide device length tracking data for monitoring and controlling device movements within the chamber.

A “Set Retraction Limit” command allows the user to set a limit that prevents the catheter from being retracted too far, so that it ensures that the catheter is not inadvertently withdrawn from the supporting chamber or the chamber of interest.

A “Move Absolute” command with a length specification by the user is provided such that the user can move the device (forward or backward depending on the situation) to the specified length, measured relative to the reference position of the device. A “Move Relative” command with a user-defined length specification allows for relative movements of the device forward or backward by a length determined by the user.

A pre-defined change in steering control variable of the remote navigation system serves to steer the device to a pre-determined orientation or configuration, so that a sequence of mapping steps can be started from an approximately known anatomical position. In the case of a magnetic navigation system that actuates or steers the device with an externally applied magnetic field, a “Set Field Direction” operation serves to define a starting configuration for the device. In the case of a mechanically actuated remote navigation system, such a starting configuration would be defined, for example, by controlling cable tensions in servo-controlled mechanical cables that serve to steer the device suitably.

Contact of the device with the wall of an anatomical chamber can be sensed by noting that when a mechanically soft catheter is moved within a chamber, if continued movement of the device is attempted after contact, the catheter shaft tends to buckle, causing a sudden sharp change in device orientation (while its tip remains almost stationary). In an “Advance device until contact” selection, the device is advanced, with a specified and fixed choice of steering control variable, until a sharp change in device tip orientation is observed. The device could be equipped with a location and orientation sensor at its tip that is connected to the localization system. Additionally or alternatively, a localization system that does not need an embedded sensor in the device could be used to monitor device tip orientation. While the corresponding deflection threshold or orientation change can be defined with default values as part of the remote navigation system in one embodiment, in an alternate embodiment it could be user-defined. In a magnetic navigation system a function of the angle between the applied magnetic field and device tip orientation could be monitored with a suitably defined threshold indicating contact.

In a similar manner, with the length of device held constant, a change in steering control variable can be applied until a sharp change is observed in the difference between actual device tip orientation and expected device tip orientation based on the current steering control variable, as the steering control variable is changed. In the case of a magnetic navigation system where the steering control variable is an externally applied magnetic field, the quantity monitored for a sharp change can be directly the angle between current magnetic field direction and current device tip orientation. Alternatively, the expected device tip orientation can be computed from the current value of the steering control variables (this could be tensions in mechanically actuated steering cables in the case of a mechanically actuated remote navigation system), and the difference between the actual and expected device tip orientations can be monitored for sharp changes. In another embodiment, more generally a first function of the angle between the device tip orientation and a second function of a control variable can be used as a measure of contact, where the control variable can be a magnetic field orientation in the case of a magnetic navigation system or a servo motor configuration in the case of a mechanically actuated remote navigation system.

Analogously, the catheter or device can be dragged back or retracted while ensuring that tip contact with the chamber wall is maintained. A “Drag with Contact” selection implements this by initially applying a control variable such that the catheter is over-torqued or over-steered, as determined by monitoring the difference between actual device tip orientation and expected device tip orientation based on the current steering control variable as a measure of contact (as described above). Again in the case of a remote magnetic navigation system, the angular difference between field orientation and tip orientation can be used instead as a measure of contact, as detailed earlier. Subsequently the catheter is dragged back in pre-determined or user-defined steps while monitoring the contact measure. If the contact measure falls below a predetermined threshold value, this is taken to mean a loss of device tip contact with the chamber wall.

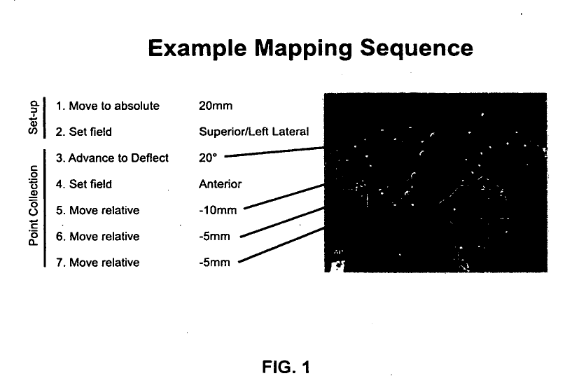

Once a sequence of steps has been chosen by the user (each step being one of the above-mentioned possibilities), the system can execute the sequence automatically. In one preferred embodiment, the remote navigation system can indicate to the user the completion of a step or a sub-step by means of a suitably displayed text message on a graphical user interface, an audible sound such as a beep or audio tone, or other means of indication. The user can then choose to “acquire a point” or choose and store the current catheter tip location as a data point in a localization system which uses such three dimensional coordinate data to create an anatomical map. An example of such an anatomical map is shown in FIG. 1. FIG. 1 illustrates an exemplary map obtained using an implementation of an automated anatomical mapping process. A remote magnetic navigation system is used to define a sequential series of device movements in a combination of device orientations/deflections and/or orientation changes controlled or defined by an external magnetic field and device length changes. Four device tip positions on an anatomical map of a left atrium created by this process are also indicated.

The foregoing automated mapping methods and apparatus facilitate the quick creation of maps during medical procedures. Automated mapping is as fast as, or faster than, manual methods. Wasted movements are eliminated or minimized. The foregoing basic movements are gentle, clinically safe, and result in accurate maps when implemented in a navigation system. Point collection can be maximized while movements can be minimized.

What is claimed is:

1. A method of defining automated movement sequences of a remotely controlled medical device actuated by a remote navigation system, the method comprising the steps of: (a) defining a reference length for a medical device inserted into an anatomical chamber where subsequent device length measurements are made and automated device length changes are applied with respect to the reference length, and (b) defining a movement sequence as a concatenation of automated movement building block primitives for subsequent automated execution by the remote navigation system.

2. The method of claim 1, where the concatenation of movement primitives is specified by a user.

3. The method of claim 1, where the concatenation of movement primitives is pre-defined on the remote navigation system.

4. The method of claim 1, where at least one movement parameter associated with at least one of the movement primitives is specified by the user.

5. The method of claim 4, where at least one of the user-specified movement parameters is a device advancement length.

6. The method of claim 4, where at least one of the user-specified movement parameters is a device retraction length.

7. (canceled)

8. (canceled)

9. (canceled)

10. (canceled)

11. (canceled)

12. The method of claim 1, where device length in at least one of the movement primitives is defined in an absolute sense with respect to the reference length.

13. The method of claim 1, where device length change in at least one of the movement primitives is defined in a relative sense with respect to the currently measured device length.

14. (canceled)

15. (canceled)

16. (canceled)

17. (canceled)

18. (canceled)

19. An automated method of operating a remote navigation system comprising an orientation system for orienting the distal end of a medical device and a positioning system for advancing and retracting the medical device, the method comprising: operating the positioning system to automatically advance the medical device in response to a user command until the device makes contact with an anatomical surface, and discontinuing advancement of the device upon detecting device contact with an anatomical surface.

20. The method of claim 19, where the medical device tip orientation is tracked by a localization system.

21. The method of claim 20, where contact with an anatomical surface is determined by the remote navigation system by continuously monitoring for a sharp change in device tip orientation indicating the device tip is in contact with an anatomical surface.

22. The method of claim 21, where the sharp change in device orientation is defined by a pre-defined threshold value of orientation change within a pre-defined time interval.

23. The method of claim 21, where the sharp change in device orientation is defined as a threshold value for a first function of the angle between the device tip orientation and a second function of a control variable.

24. The method of claim 23, where the control variable is an externally applied magnetic field.

25.-61. (canceled)

62. A control for operating a remote navigation system comprising an orientation system for orienting the distal end of a medical device and a positioning system for advancing and retracting the medical device, the control acting in response to a user command to operate the positioning system to retract the medical device while the distal tip of the device remains at an orientation indicative of contact with an anatomical surface, and discontinuing retraction of the device upon detecting device contact with an anatomical surface.

63. The control of claim 62 wherein the control operates the positioning system to retract the medical device until a predetermined change in orientation of the distal tip of the medical device.

64. The control of claim 62 wherein the control operates the positioning system to retract the medical device until a predetermined change in orientation of the distal tip of the medical device or a predetermined length of retraction.

65. The control of claim 62 wherein the control operates the positioning system to retract the medical device until the distal tip comes within a predetermined amount of an angular orientation indicating contact with an anatomical surface.

66. The control of claim 62 wherein the control operates the positioning system to retract the medical device until the distal tip comes within a predetermined amount of an angular orientation indicating contact with an anatomical surface or a predetermined length of retraction.

67.-74. (canceled)

75. The control of claim 62 further including a graphical user interface comprising an element displayed on a display, which when activated causes the positioning system to operate to advance the medical device until a change in the distal end of the medical device indicates the distal end is in contact with an anatomical structure.

76.-80. (canceled)
